(19) United States
(12) Patent Application Publication
(10) Pub. No.: US 2006/0112601 A1
(43) Pub. Date: Jun. 1, 2006

(54) Brite banner

(76) Inventor: Robert Childress, Tampa, FL (US)

Correspondence Address: Robert Childress, 8402 Sabal Industrial Blvd., Tampa, FL, 33619, US

(21) Appl. No.: 10/995,154

(22) Filed: Nov. 24, 2004

(51) Int. Cl. G09F 13/00

(52) U.S. Cl. 40/541

(57) ABSTRACT

This product is a mesh banner designed to be viewed from one or both sides. It can have designs and or text, printed on one or both sides with flexible electric lighting behind, in the case of a one sided banner or between two banners in the case of two Sided banners. These banners provide the capability of having visible designs and or text in daylight and illuminated text and or designs in the dark.

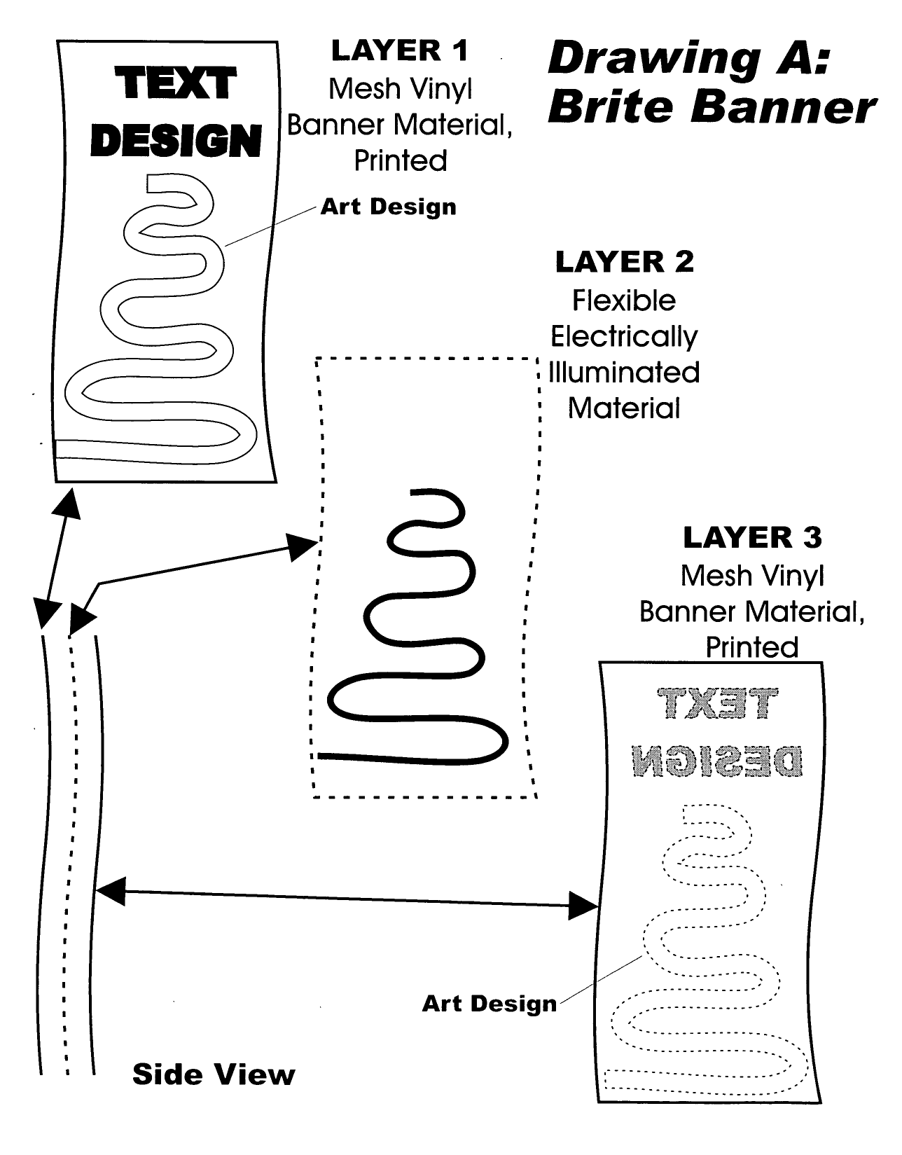

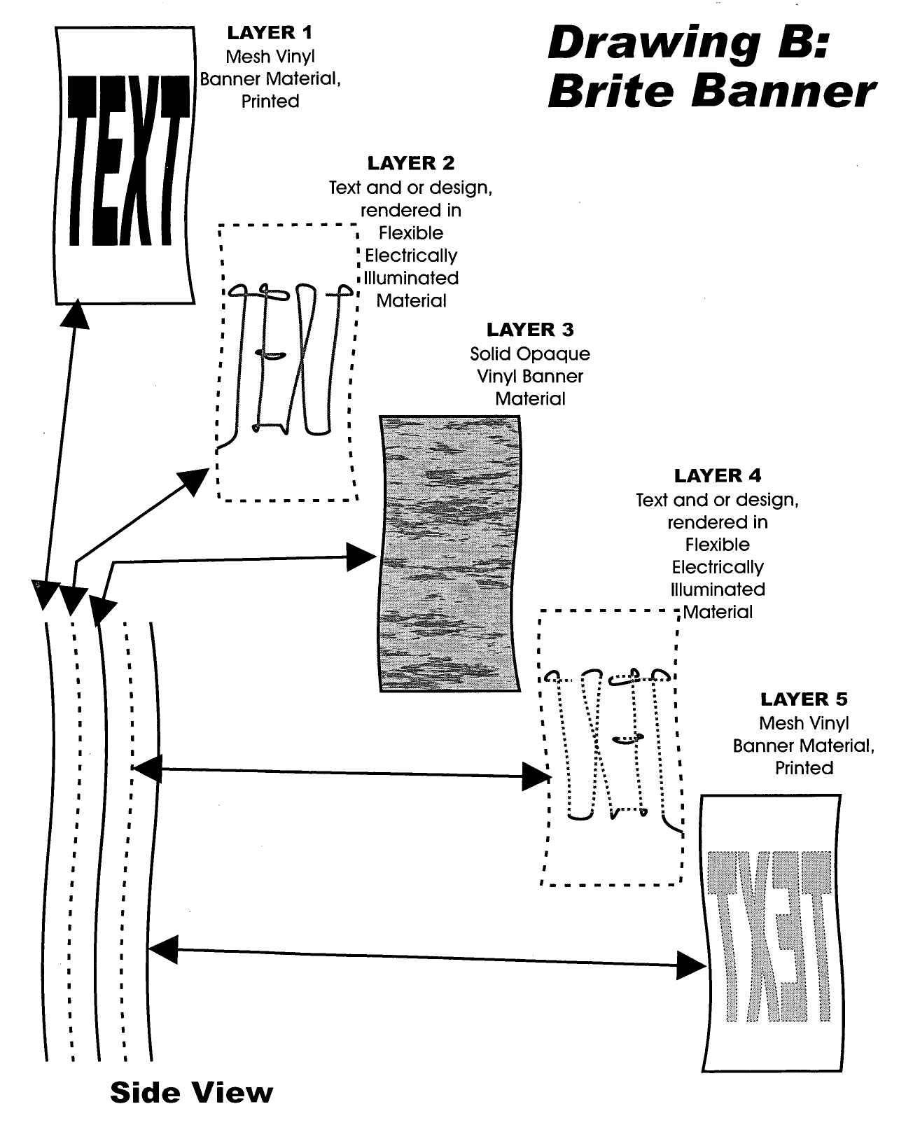

The practical use of this product is for advertising, seasonal decorations, etc. and can be viewed in Either daylight or night.

### DESCRIPTION OF DRAWING A

Drawing A. is a product that the electrically illuminated part of the banner may be correctly viewed from either side. Examples of these are trees, bells, snowflakes, etc.

It is constructed in the following manner:

Layer one, or top layer, is a mesh banner which allows the underlying electrically illuminated area to show through the mesh in the dark and is printed with text and or designs using inks as outlined in the description. Layer two consists of electrically illuminated materials as outlined in the description and attached to the back side of layer one. Layer three is then printed in reverse, allowing for text or designs to be read correctly from the back side on a mesh banner, again to allow the electrically illuminated materials to show through, and attached to layer one. This results in a two sided banner with electrically illuminated designs sandwiched between the front and back panels.

### DESCRIPTION OF DRAWING B

Drawing B. is a product that the electrically illuminated part of the banner may not be correctly viewed from either side. Examples of these are written words, logos, etc.

It is constructed in the following manner:

Layer one, or top layer, is a mesh banner which allows the underlying electrically illuminated area to show through the mesh in the dark and is printed with text and or designs using inks as outlined in the description. Layer two consists of electrically illuminated materials as outlined in the description and attached to the back side of layer one. Layer three is an opaque banner used to block the illumination from showing through to the back of the fmished banner. Layer four is another layer of electrically illuminated materials and attached to the back of layer five. Layer five or the back of the banner is printed in the same manner as layer one and may or may not have the same text or designs. This results in a two sided banner with two sets of electrically illuminated designs. Two sets of electrically illuminated materials are required in order for the text and or design to be correctly viewed from either side.

1. I claim the product, Brite Banner, to be a flexible banner, in varying sizes. The materials used in the manufacturing of this product are mesh vinyl banner material and electrically illuminated lighting that allow flexibility. In some cases, such as when text, logo or design dictate, a solid opaque vinyl material will be incorporated into the product. These instances will be further explained in the description page of the drawings.
The inks used to print these banners are non-reflective, reflective, and or phosfluorescent. Phosfluorescent ink allows the ink to receive energy during daylight hours from the sun resulting a glowing property in the dark. These inks allows for the printed words and or designs to be visible in daylight and to a lesser degree in the dark.
There are two designs of this product. One design, drawing A., has a common electrically illuminated image. Examples are a tree, snowflake, bell etc. that is correctly viewable from both sides, front or back. This banner is manufactured in three layers. The first layer is a printed mesh banner. The second layer is electrically illuminated material, which is attached to the back of level one. The third and final layer is a mesh banner printed mirror image to the mesh banner of level one which allows the two-sided illuminated banner to read correctly from either side. They are then sandwiched together and sewn, creating a two-sided banner with a common electrically illuminated design to be viewed front and back.
The second design, drawing B., is where the illuminated portion of the banner is not common for correct viewing from both sides. Examples are words, logos etc. This banner is manufactured in five layers. The first layer is a printed mesh banner. The second layer is electrically illuminated material, which is attached to the back layer one. The third level is opaque vinyl banner material which purpose is to block the illumination from showing through to the back of the banner. The forth layer is another layer of electrically illuminated material which is attached to the back of layer five, another mesh banner, allowing the illunination to show through the back of the banner. These layers are then sandwiched together and sewn creating a two-sided banner with different electrically illuminated designs to be viewed front and back.
The power supply may be A.C. or D.C.
The practical use of these banners is for advertising, seasonal decorations etc. and can be seen in either daylight or at night.
